(19) United States
(12) Patent Application Publication
(10) Pub. No.: US 2015/0347357 A1
(43) Pub. Date: Dec. 3, 2015

(54) SYSTEMS AND METHODS FOR AUTOMATIC TEXT RECOGNITION AND LINKING

(71) Applicant: Rovi Guides, Inc., Santa Clara, CA (US)

(72) Inventors: Benjamin Maughan, Pleasanton, CA (US); Brian Peterson, Barrington, IL (US); William Korbecki, Crystal Lake, IL (US); Paul Stathacopoulos, San Carlos, CA (US)

(21) Appl. No.: 14/448,600

(22) Filed: Jul. 31, 2014

Related U.S. Application Data
(60) Provisional application No. 62/005,220, filed on May 30, 2014.

(51) Int. Cl. G06F 17/22; G06F 3/0484; G06F 3/0482; G06F 17/27

(52) U.S. Cl. CPC G06F 17/2235; G06F 17/2775; G06F 17/2247; G06F 3/04842; G06F 3/0482

(57) ABSTRACT

Systems and methods described herein provide for automatically linking words/phrases in messages to corresponding associated objects (e.g., information sources). A message (e.g., social network posting, email, text message) is submitted by a user to a server (e.g., social network server, email server, text messaging server). The server performs text recognition on the message and identifies a plurality of objects that are associated with a selected portion of the message (e.g., word/phrase related to a media asset). An object is selected from the associated objects as a match for the selected portion of the message. The submitted message is modified to visually distinguish the selected portion of the message as a selectable link to a display related to the selected match. The modified, linked message is displayed to the user.

### CROSS REFERENCE TO RELATED APPLICATION

This disclosure claims the benefit under 35 U.S.C. §119(e) of U.S. Provisional Application No. 62/005,220, filed May 30, 2014, which is incorporated herein by reference in its entirety.

### BACKGROUND

Users often share their content preferences with other users through messages. These messages may be sent through various modes of communication. For example, these messages may be posted online (e.g., social network, blog), or sent through email or text message, just to name a few. Regardless of the mode of communication, it may be desirable for both creators and recipients of the message to easily link to information that is referenced in the message. Conventional systems typically require a user to manually link a word or phrase in the message to a corresponding information source. However, users often neglect to activate these linking mechanisms due to inconvenience. Consequently, users who receive the messages do not have a convenient way to quickly access information that is referenced in the messages.

### SUMMARY

Accordingly, systems and methods are described herein for automatically linking words/phrases in messages to corresponding information sources. This automatic linking mechanism provides convenience to both creators and recipients of the messages. The automatic linking obviates manual linking by the creator of the message, while providing recipients quick access to sources of information referenced in the message.

For example, a user may post a message to a social networking website that praises a recently watched movie (e.g., “Just watched The Dark Knight. What an AMAZING movie!”). The social networking server automatically performs text recognition on the submitted message to determine whether any words/phrases in the message are associated with a media asset (e.g., movie, TV show, song). The server determines that the phrase “The Dark Knight” is the title of a movie asset and cross-references the movie title with related objects in a database. For example, these cross-referenced objects may refer to, but are not limited to, the movie itself, other movies in the series, media assets with similar content, media assets with a similar title, persons associated with the movie (e.g., actors, characters, directors, etc.), and the soundtrack of the movie. The server may prompt the user who submitted the message to select a matching object (e.g., “The Dark Knight (The Movie)”) from a list of the cross-referenced associated objects. The submitted message may be automatically modified to include a link to a display related to the matching object. Then, the newly linked version of the message is posted on the social networking website. For example, the phrase “The Dark Knight” in the submitted message, which was previously unlinked, is automatically linked by the server to an information source related to “The Dark Knight” (e.g., the official home page of “The Dark Knight” movie).

In some aspects, the systems and methods described herein may store a message that was submitted to a server. For example, this message may be created by a user and submitted as a post to a website, an email, a text message, or any other type of message sent over any communication medium. The server may perform text recognition on the message that was stored.

Based on the text recognition, the server may select a portion of the message (e.g., the phrase “The Dark Knight”). For example, the server may determine that a particular phrase (e.g., “The Dark Knight”) used in the message is associated with a media asset (e.g., the movie “The Dark Knight”) and select that phrase to be cross-referenced with a database. For example, this database associates certain words/phrases with related objects.

The server automatically identifies, without receiving user input to identify, a plurality of objects associated with the selected portion, wherein each of the plurality of associated objects is cross-referenced with the selected portion (e.g., “The Dark Knight”). For example, the plurality of objects that are cross-referenced with the phrase “The Dark Knight” may include the movie object itself (e.g., “The Dark Knight (the movie”)), other movies in the same series (e.g., “Batman Begins”), media assets with similar content (e.g., media assets about the Batman superhero or media assets in the superhero genre in general), media assets with a similar title (e.g., the movie “The Dark Knight Rises”) characters in the movie (e.g., “The Joker” character), actors in the movie (e.g., the actor Christian Bale who plays Batman, the actor Heath Ledger who plays “The Joker” character), and the soundtrack of the movie.

An object is selected, from the plurality of associated objects, as a match for the selected portion of the message. For example, the object corresponding to the movie itself (e.g., “The Dark Knight” movie) may be selected as a match.

The submitted message is then modified so that the selected portion of the message (e.g., the phrase “The Dark Knight”) is visually distinguished (e.g., underlined, highlighted in a different text color) as a selectable link (e.g., a hyperlink to a webpage). This selectable link may link to a separate display related to the selected object (e.g., a hyperlink to the official home page of “The Dark Knight” movie).

The modified, linked version of the message is then generated for display. For example, the hyperlinked version of the message is then posted on the social networking site.

In some embodiments, the text recognition of the submitted message is performed by identifying a word or phrase that is associated with a media asset. For example, the identified word or phrase may be a title of a media asset. In another example, the identified word or phrase may be a name of a person associated with a media asset, such as an actor, director, producer, or character in the media asset. The portion of the message with the identified word or phrase may then be selected by the server for further processing.

In some embodiments, the message was submitted to the server in response to a user selection of an option to post the message on a webpage hosted by the server. For example, the message may have been created as a message post for a social networking website. To submit this message, a user may select a “submit” option on a webpage of the social networking website, where the webpage is hosted by the social networking server. The submitted message may not be displayed before text recognition is performed on the message. For example, the user may select the “submit” option on the social networking webpage, but the message is not actually posted on the webpage until after the text recognition and subsequent linking process is performed. For example, if the message contains phrases/words related to media assets, only the modified, linked version of the message may be posted on the webpage and not the originally submitted, unlinked version of the message.

In some embodiments, the objects that are cross-referenced in the database with the selected portion of the message may be associated with a media asset in a number of different ways. One or more of the objects may be a media asset. For example, an object may be a movie, television show, song. One or more of the objects may be a person associated with a media asset. For example, an object may be an actor, character, director, or any other person who performs in or is involved in making the media asset. One or more of the objects may be a product associated with a media asset. For example, an object may be a game, song, or toy that is associated with the media asset. One or more of the objects may be an advertisement associated with a media asset. For example, an object may be a commercial, trailer, or promotional activity associated with the media asset. One or more of the objects may be an event associated with a media asset. For example, an object may be a premier of a movie, a broadcast, delivery, or release time of a media asset, or a promotional event associated with a media asset.

In some embodiments, the submitted message is generated for display on a webpage that is hosted by the server, wherein the submitted message is displayed prior to the display of the modified message. For example, when a user initially submits the message, the unlinked message may automatically be displayed on the social networking website. After the unlinked message is displayed, the host server may identify one or more words/phrases in the displayed unlinked message to the user and prompt the user to link one or more of the identified words/phrases. The modified, linked version is then displayed on the social networking website.

In some embodiments, a user selects an option to create a link for the displayed message that is unlinked. For example, the user may select an “add link” option to create a link for a previously submitted unlinked message that is displayed on a social networking website. In response to this user selection, a list of a plurality of associated objects is displayed to the user, wherein each of the listed objects is selectable by a user. For example, this list may be a drop-down list containing items that may refer to an identified word/phrase in the unlinked message. For example, if the identified word/phrase is “The Dark Knight”, the displayed list may contain items including “The Dark Knight (the movie)”, “The Dark Knight Rises (the movie)”, “The Dark Knight (the soundtrack)”, or any other objects that are cross-referenced with the identified phrase “The Dark Knight” (see, e.g., FIG. 8). The user may then select one of the selectable items from the displayed list as a match for the selected portion of the message. For example, the user may select the listed item that corresponds to “The Dark Knight (the movie”), since the user intended the phrase “The Dark Knight” to refer to “The Dark Knight” movie when creating the message.

In some embodiments, the server selects the match from the plurality of objects, without receiving user input to select the match. For example, after a message is submitted by the user to the server, the server may process the submitted message and automatically select a match for a word/phrase in the message, without receiving user input for the match.

In some embodiments, this match is automatically selected by the server by determining a value that indicates a level of popularity of each of the plurality of associated objects. For example, a server may determine how many “likes” a particular object has. A “like” represents an approval rating assigned by a user. For example, these “likes” may have been inputted by a user for the object on one or more websites. The server may then assign the popularity value for the object based on the number of likes. The server may then automatically select the object with the highest assigned value as the “match”. For example, if the movie object “The Dark Knight (the movie)” has the most “likes” of all the other objects associated with the phrase “The Dark Knight”, the server may automatically select this movie object as the matching object for the phrase.

In some embodiments, the message is submitted as a text message from a mobile phone. For example, the text message may be sent to a telecommunications server which stores text messages sent by users. The telecommunications server may perform text recognition on those text messages to automatically link words/phrases in the text messages to information sources. After modifying the text messages with the links, the telecommunications server may send the modified text messages to recipients of the respective text messages.

In some embodiments, the selectable link that is visually distinguished in the message links to a display which is a web page that provides information related to a media asset. This information may include a description of the media asset. For example, this information may be a page that provides a brief summary of the movie “The Dark Knight”. This information may include a person associated with the media asset. For example, this information may provide a list of actors, directors, products, characters or other persons associated with the move “The Dark Knight”. This information may include media assets that are related to the media asset. For example, this information may list media asset that are similar in content, theme, and/or title to the movie “The Dark Knight”. This information may include availability of the media asset. For example, this information may provide the times the movie “The Dark Knight” is playing theaters and/or the times the movie “The Dark Knight” becomes available for streaming, recording, rental, or purchase. This information may include information for accessing the media asset. For example, this information may provide instructions for how to watch the movie “The Dark Knight”, such as venues for watching, renting, or purchasing the movie. This information may also provide a user with an option to schedule a remote recording on the user's recording device, set a reminder to watch the movie at a later time, or begin watching the movie. This information may include commentary about the media asset posted by users. For example, this information may include reviews or other comments by the users about the movie “The Dark Knight”.

It should be noted, the systems and/or methods described above may be combined with, applied to, or used in accordance with, other systems, methods and/or apparatuses discussed both above and below.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the disclosure;

FIG. 3 shows an illustrative user equipment device in accordance with another embodiment of the disclosure;

FIG. 4 is a diagram of an illustrative cross-platform interactive media system in accordance with another embodiment of the disclosure;

FIG. 5 is an illustrative message that has not been linked in accordance with some embodiments of the disclosure;

FIG. 6 is an illustrative message that has been automatically linked in accordance with some embodiments of the disclosure;

FIG. 7 is an illustrative message that has been automatically linked in accordance with some embodiments of the disclosure;

FIG. 8 is an illustrative user interface for selecting a matching object for a given portion of an unlinked message in accordance with some embodiments of the disclosure; and

FIG. 9 is an illustrative flow chart for automatically linking a portion of a message that is submitted to a server in accordance with some embodiments of the disclosure.

### DETAILED DESCRIPTION OF DRAWINGS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

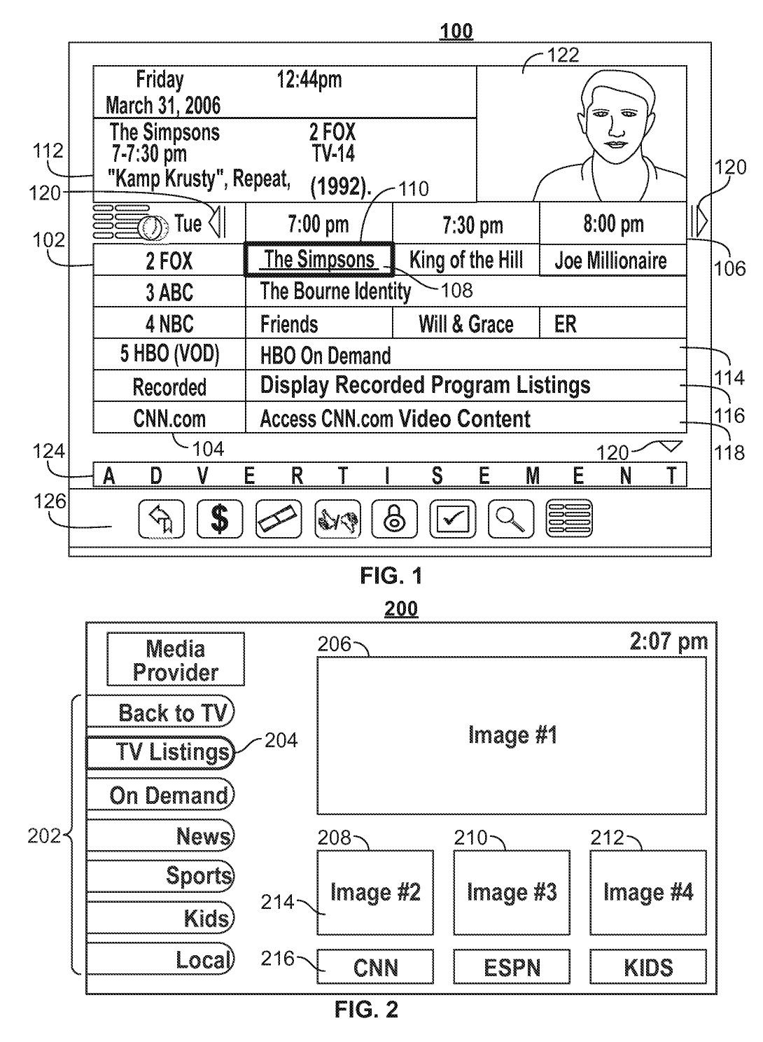

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, I I I et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

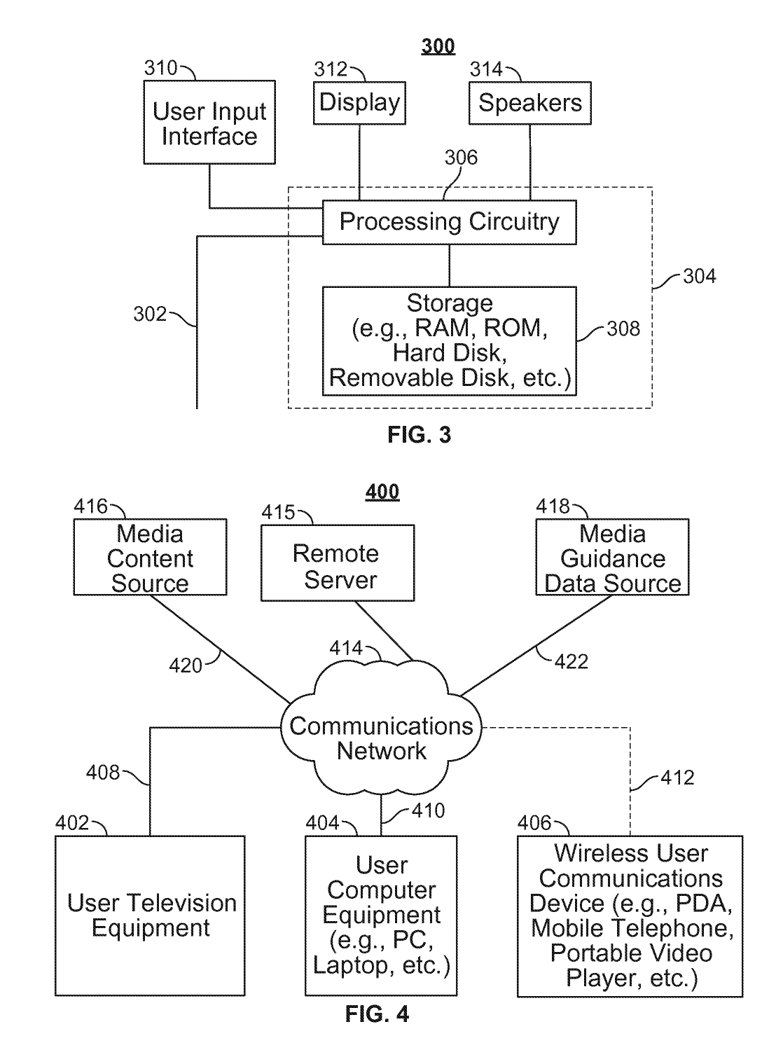

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server 415. For example, the remote server 415 may store the instructions for the application in a storage device. The remote server 415 may process the stored instructions using circuitry (e.g., control circuitry 304) and generate the displays discussed above and below. The client device may receive the displays generated by the remote server 415 and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server 415 for processing and generating the corresponding displays. For example, equipment device 300 may transmit a communication to the remote server 415 indicating that an up/down button was selected via input interface 310. The remote server 415 may process instructions in accordance with that input and generate a display of the application corresponding to the input (e.g., a display that moves a cursor up/down). The generated display is then transmitted to equipment device 300 for presentation to the user.

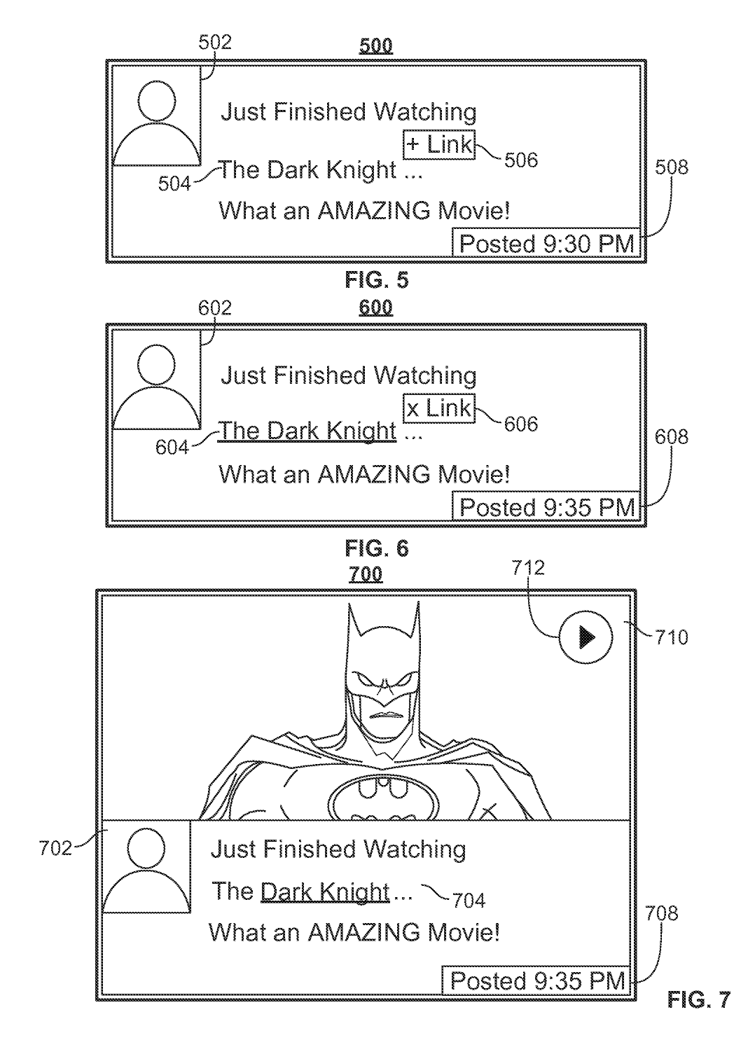

In some embodiments, remote server 415 may receive messages submitted from a user at a user equipment device 300. Storage circuitry (not shown in figures) of remote server 415 may store these received messages in storage of remote server 415. As referred to herein, “message” or “messages” should be understood to mean a piece of text. A message may be short or long and may contain images or forms of information, in addition to text. A message may be written or created by a user or any other non-user entity. As referred to herein, the term “submitted” or “submission” (or any variant thereof) should be understood to mean a request to send something. For example, a “submitted message” should be understood to mean a request to send a message. As referred to herein, the term “posted” or “post” (or any variant thereof) should be understood to mean displayed or generated for display. For example, the time at which a message is “posted” (e.g., see time 508 in FIG. 5) corresponds to a time at which the message is displayed on user equipment device 300 or generated for display by remote server 415.

In some embodiments, remote server 415 may be a website server that hosts webpages for any online website (e.g., social networking website, blog, online newspaper, etc.). In such embodiments, the received messages may correspond to online postings created by the user to be displayed on the website. For example, these online postings may be comments or messages created for display on a social networking website or lengthier articles created for display on an online blog or newspaper.

In some embodiments, remote server 415 may be an email server that hosts emails for an email server. In such embodiments, the received messages may correspond to emails written by the user to be sent to one or more identified recipients.

In some embodiments, remote server 415 may be a telecommunication server which hosts various communications, such as text messages, for a telecommunications provider. In such embodiments, the received messages may correspond to text messages that are sent by a user of a mobile device 404 to one or more identified recipients. For example, the text message may be sent over communications network 414 to wireless user communications device 406.

Remote server 415 may comprise its own control circuitry (not shown in figures) to perform text recognition on the received messages that are stored in storage of remote server 415. In some embodiments, remote server 415 may perform text recognition on the messages by using text recognition software that is installed on the server 415.

In some embodiments, control circuitry of remote server 415 may instruct a separate text recognition server (not shown in figures) to perform text recognition on the messages that are stored on 415. The separate text recognition server may have its own text recognition engine that performs text recognition.

In some embodiments, user equipment device 300 may perform text recognition on the messages before submitting the messages to remote server 415. The user equipment device 300 may also send results of the text recognition to remote server 415 along with the message.

The text recognition process, whether it is performed by control circuitry of remote server 415, control circuitry of a separate text recognition server (not shown in figures), or control circuitry 304 of user equipment device 300, involves recognizing text that corresponds to words. In some embodiments, the control circuitry cross-references a word or phrase with a database to determine whether the word or phrase corresponds to an object. This object may be related to a media asset, and this database may reside on media content source 416 or media guidance data source 418. As referred to herein, a “phrase” should be understood to mean a consecutive sequence of two or more words. As referred to herein, an “object” should be understood to mean any entity that is associated with a media asset. For example, an object may be, but is not limited to, the media asset itself, a person associated with the media asset, or any information or information source associated with the media asset.

For example, control circuitry of remote server 415 may extract a phrase from a stored message and cross-reference that phrase with a database located at media content source 416 or media guidance data source 418. The database may contain a plurality of entries, where each entry in the database associates a word or phrase with one or more objects.

Remote server 415 may also store or have access to a database that associates objects with information sources related to the objects. For example, an information source may be a file that provides information about the object. In some instances, the file may be hosted by the remote server 415. For example, the file may be a webpage that is hosted by a social networking server 415. The information source may be accessed by a link. As referred to herein, a “link” should be understood to mean an address or a pointer to an address of a particular file. For example, the link may specify the location of an information source. For example, the link may be a hyperlink address which specifies which server connected to communications network 414 stores the information source. This server may be remote server 415 or any other server connected to communications network 414. For example, the information source may be a file stored at media content source 416 or media guidance data source 418. In another example, the link may be an address to a local file that is stored on user equipment device 300. In such cases, remote server 415 would access the information source by communicating with user equipment device 300 and providing user equipment device 300 with the local file address.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server 415. For example, media guidance applications may be implemented partially as a client application on control circuitry 304 of user equipment device 300 and partially on a remote server 415 as a server application (e.g., media guidance data source 418) running on control circuitry of the remote server 415. When executed by control circuitry of the remote server 415 (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

A user of user equipment device 300 may wish to submit a message to remote server 415. In some embodiments, the user may submit a message that includes a word or phrase that is associated with an object. In some cases, the user may neglect to manually link the word or phrase to the object. In such instances, control circuitry of remote server 415 receives the unlinked message and instructs the unlinked message to be displayed.

FIG. 5 shows an illustrative message 500 that has not been linked in accordance with some embodiments of the disclosure. In some embodiments, unlinked message 500 may be posted by control circuitry of remote server 415. The time of posting 508 corresponds to the time remote server 415 generated the submitted unlinked message 500 for display. In some embodiments, control circuitry of remote server 415 may post the unlinked message 500 prior to performing text recognition on the unlinked message 500. In other embodiments, control circuitry of remote server 415 may post the unlinked message 500 after performing text recognition on the message 500.

In any of the above-mentioned embodiments, the user who submits message 500 to remote server 415 may be identified by a user icon 502 in the message 500. Message 500 may comment on a particular media asset. As shown in FIG. 5, user 502 may create a message that comments on a particular movie asset (e.g., “Just finished watching The Dark Knight . . . . What an AMAZING movie!”). Control circuitry of remote server 415 may perform text recognition on the submitted unlinked message 500. As a result of performing the text recognition on message 500, control circuitry of remote server 415 may determine that a portion of message 500 corresponds to a word/phrase 504 (e.g., The Dark Knight) that is associated with one or more objects.

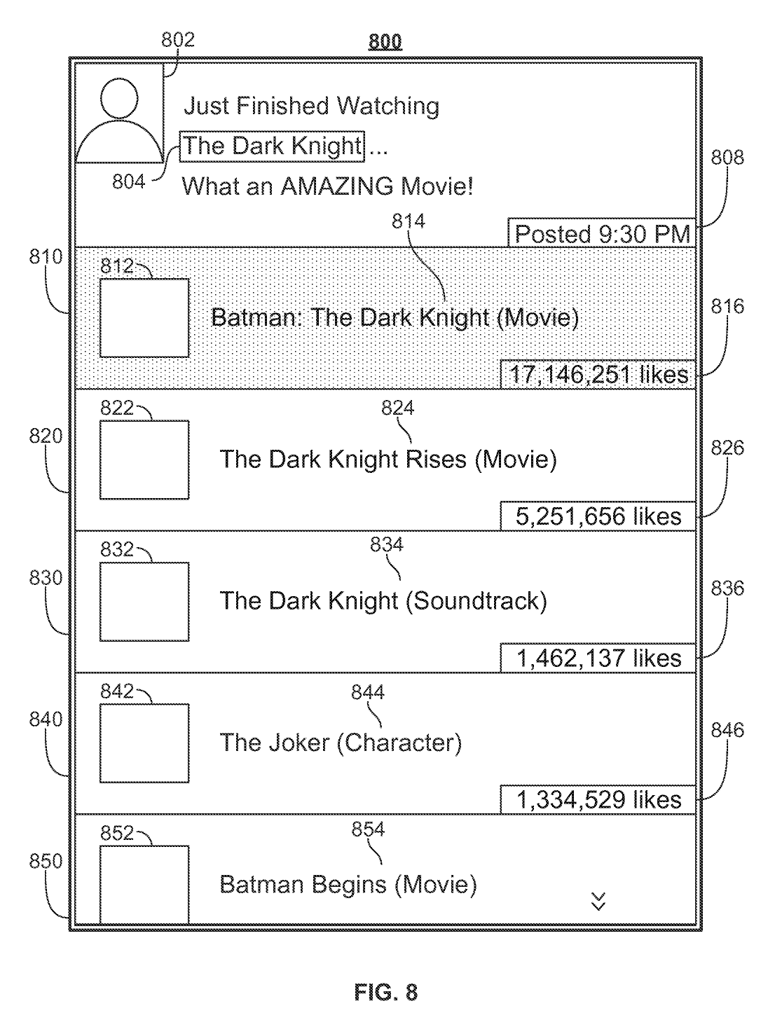

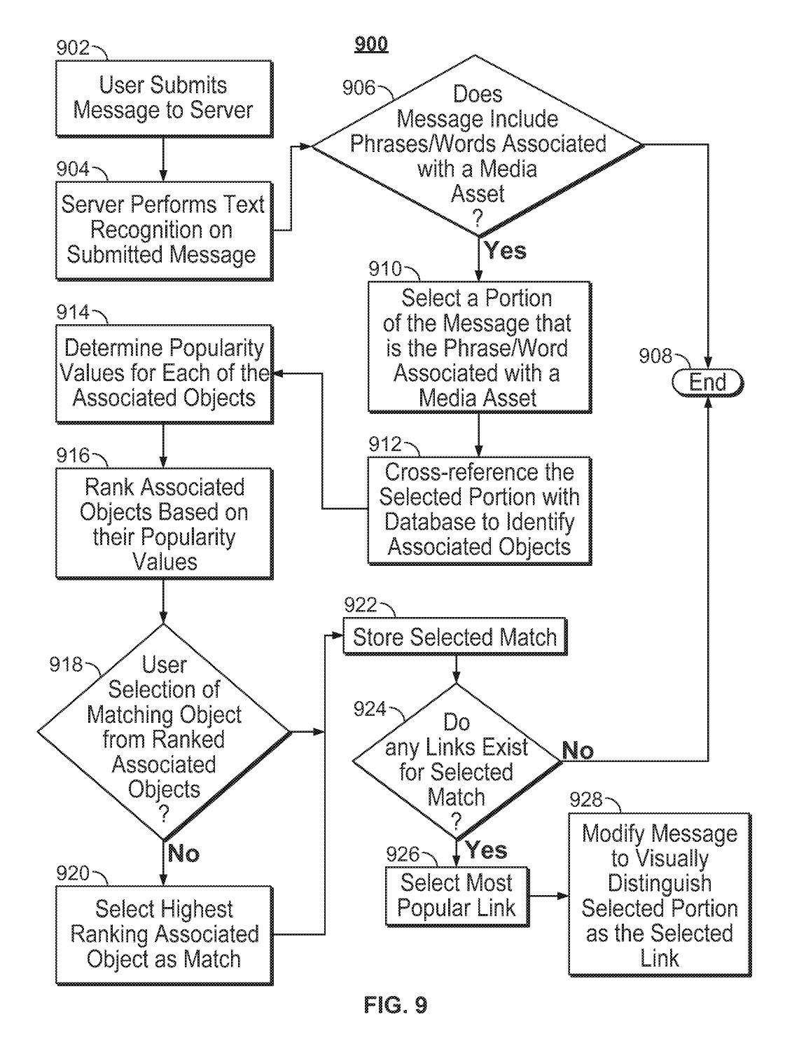

For example, control circuitry of remote server 415 may determine that unlinked message 500 refers to a movie object 504 and thus may be linked to information sources related to the movie object 504. Further details about the linking process are discussed in relation to FIG. 9 below. In response to the determination that phrase 504 may be linked, control circuitry of remote server 415 may generate for display an option 506 to create a link from a word/phrase in the message to a corresponding information source. In response to receiving a user selection of option 506, remote server 415 may generate for display a user interface 800 which allows a user to select a matching object that is associated with phrase 504 in the message. Further details about user interactions with user interface 800 are discussed in relation to FIG. 8 below.

FIG. 6 is an illustrative message 600 that has been automatically linked in accordance with some embodiments of the disclosure. In some embodiments, control circuitry of remote server 415 may post linked message 600 in response to a user selection of option 506 to create a link for unlinked message 500. Details about this user selection were discussed in relation to FIG. 5 above and are further discussed in relation to FIG. 8 below.

In other embodiments, control circuitry of remote server 415 may automatically post linked message 600 without any user input to link an unlinked message (e.g., message 500). In such embodiments, control circuitry of remote server 415 may receive a message that was submitted by user 602 to remote server 415. Control circuitry of remote server 415 may then perform text recognition on the stored submitted message. As a result of this text recognition process, control circuitry of remote server 415 may automatically identify, without user input to identify, a plurality of objects associated with a word/phrase in the message. For example, control circuitry of remote server 415 may determine a portion of the submitted message includes a word/phrase 604 (e.g., “The Dark Knight”) that is associated with one or more objects related to a media asset.

Control circuitry of remote server 415 may then automatically select, without user input to select, one of the identified plurality of objects as a match for the word/phrase (e.g., “The Dark Knight”). For example, control circuitry of remote server 415 may select the matching object as “The Dark Knight” movie object.

Control circuitry of remote server 415 may then modify the submitted message to visually distinguish the word/phrase in the message as a selectable link to a display related to the selected matching object. For example, control circuitry of remote server 415 may embed the submitted message with a link to an information source that provides further information about “The Dark Knight” movie. In some embodiments, this link may be visually distinguished in message 600 by an underline 604. In other embodiments, the word/phrase 604 (e.g., “The Dark Knight”) may be visually distinguished in other ways. For example, the color of text of the word/phrase 604 may be different from the rest of the text in message 600 (not shown). Control circuitry of remote server 415 may then post the modified, automatically linked message 600. Further details about this automatically linking process are discussed in relation to FIG. 9 below.

Linked message 600 may be posted publically to all users or privately to one or more recipients. In response to receiving a user selection of selectable link 604 of posted message 600, control circuitry of remote server 415 may direct the user to a display related to the object that is associated with the linked word/phrase 604. For example, since the phrase “The Dark Knight” 604 is linked to a movie object called “The Dark Knight”, control circuitry of remote server 415 may direct the user to a link that provides information related to “The Dark Knight” movie. In some embodiments, this information may include a description of a media asset (e.g., a plot summary of “The Dark Knight” movie). In some embodiments, this information may be about a person associated with a media asset (e.g., biographies of characters in “The Dark Knight” movie, biographies of actors/producers/directors or any other person involved in making “The Dark Knight movie”). In some embodiments, this information may be about media assets related to a media asset (e.g., information about media assets that are related in content, theme and/or title to “The Dark Knight” movie). In some embodiments, this information may be about availability of a media asset (e.g., the times the movie “The Dark Knight” is playing theaters and/or the times the movie “The Dark Knight” becomes available for streaming, recording, rental, or purchase). In some embodiments, this information may include information for accessing a media asset. For example, this information may provide instructions for how to watch the movie “The Dark Knight”, such as venues for watching, renting, or purchasing the movie. In some embodiments, this information may include commentary about the media asset posted by users. For example, this information may include reviews or other comments by the users about the movie “The Dark Knight”.

Control circuitry of remote server 415 may post the modified, automatically linked message 600 at time 608 (e.g., “9:35 PM)” and indicate this time of posting 608 in posted message 600. If message 600 was linked in response to a user selection of option 506 to create a link for a previously posted message, the time of posting 608 (e.g., “9:35 PM)” will be after the time of posting 508 (e.g., “9:30 PM) of the previously posted message.

Like unlinked message 500, posted linked message 600 may identify the user 602 that created and/or submitted the message to the server. In some embodiments, control circuitry of remote server 415 may modify linked message 600 to include an option 606 to remove the link that links word/phrase 604 to a matching object. In response to receiving a user selection of option 606 to remove the link from message 600, control circuitry of remote server 415 may modify message 600 to that the linked word/phrase 604 is no longer visually distinguished as a selectable link. For example, word/phrase 604 may no longer be a selectable hyperlink to an information source that provides more information on the matching object (e.g., “The Dark Knight” movie object).

In some embodiments, option 606 may alternatively be an option to edit, instead of remove (as shown), the current link that links word/phrase 604 to a matching object. In response to receiving a user selection of option 606 to edit the current link for word/phrase 604, control circuitry of remote server 415 may generate for display a list with a plurality of objects that are associated with word/phrase 604. The user may than select any of the listed objects as a replacement match for word/phrase 604. For example, the user may have intended to refer to movie “The Dark Knight Rises”, and not the movie “The Dark Knight”. Thus, the user may select “The Dark Knight Rises” movie object from a list of associated objects instead of “The Dark Knight” movie object. An illustrative interface for selecting the replacement match is described and discussed in relation to FIG. 8. In response to receiving a user selection of a replacement match, control circuitry of remote server 415 may re-post message 600 and update the time of posting 608 to the time at which the message 600 was re-posted.

FIG. 7 is an illustrative message 700 that has been automatically linked in accordance with some embodiments of the disclosure. Linked message 700 is similar to linked message 600, except that linked message 700 also include a selectable icon 710 that represents the matching object or the information source related to the matching object. For example, control circuitry of remote server 415 may additionally modify a submitted message from user 702 to automatically display, in posted message 700, content from the information source which is linked to word/phrase 704. Control circuitry of remote server 415 posts linked message at posting time 708. The linked portion 704 of message 700 is the same or substantially similar to the linked portion 604 of posted message 600. For example, linked portion 704 may link to a website that provides further information about the matching object (e.g., “The Dark Knight” movie).

As part of the linking process, control circuitry of remote server 415 may link word/phrase 704 to an information source that provides content related to the matching object. In some embodiments, the information source may be a website that provides further information about the matching object (e.g., “The Dark Knight” movie). In some embodiments, the information source may be the media asset that is associated with the matching object. For example, the information source may be a link to access a video or soundtrack of “The Dark Knight” movie or content of “The Dark Knight” itself. In response to receiving a user selection of selectable icon 710, control circuitry of remote server 415 may navigate the user to the information source. In some embodiments, the user may select a play option 712 displayed in message 700 to play the media asset that is linked to word/phrase 704. In response to receiving a user selection of play option 712, control circuitry of remote server 415 may navigate the user to a new display of the associated media asset (e.g., “The Dark Knight” movie) and play the media asset from the new display. Alternatively, in response to receiving a user selection of play option 712, control circuitry of remote server 415 may retrieve content of the associated media asset (e.g., “The Dark Knight” movie) from media content source 416 and automatically display the retrieved content for the user without navigating to a new display.

FIG. 8 is an illustrative user interface 800 for selecting a matching object for a given portion of an unlinked message in accordance with some embodiments of the disclosure. Control circuitry of remote server 415 generates user interface 800 for display on user equipment device 300. User equipment device 300 may receive user inputs of one or more objects (e.g., 810, 820, 830, 840, 850) displayed in user interface 800 and transmit the user inputs back to remote server 415.

Control circuitry of remote server 415 posts unlinked message 500 at time 508 or 808. In response to receiving a user selection of option 506 to link a portion 504 of unlinked message 500 to an associated object, control circuitry of remote server 415 may generate for display a list of associated objects (e.g., 810, 820, 830, 840) from which the user may select. Control circuitry of remote server 415 may visually distinguish the portion of the message 804 that is to be linked. In some embodiments, this visually distinguished portion 804 may have been automatically selected by control circuitry of remote server 415, without user input, based on the text recognition process prior to posting of the message (e.g., see FIG. 9). In other embodiments, this visually distinguished portion 804 may have been selected by a user. The message portion 804 may be visually distinguished in any way that distinguishes it from the rest of the text in the message (e.g., highlighted box, different colored text).

The list of associated objects may include any object that is associated with a selected word/phrase 804 of the message. In some embodiments, the selected word/phrase 804 may refer to a media asset (e.g., “The Dark Knight” movie). Control circuitry of remote server 415 may determine that word/phrase 804 refers to a media asset in response to performing text recognition on the submitted message. In response to determining that word/phrase 804 refers to a media asset, control circuitry of remote server 415 may access a database that cross-references phrases with one or more objects related to a media asset.

In some embodiments, the associated objects may be media assets themselves. For example, the phrase “The Dark Knight” may be cross-referenced with “The Dark Knight” movie 810, a media asset that has a similar title to “The Dark Knight” (e.g., “The Dark Knight Rises” movie 820), “The Dark Knight” soundtrack 830, and/or a media asset that is similar in content to “The Dark Knight” (e.g., “Batman Begins” movie, which is another movie in The Dark Knight trilogy). In some embodiments, an associated object may be a person associated with a media asset. For example, an associated object 840 may be a character in “The Dark Knight” movie, such as “The Joker”. In another example, the associated object may be an actor, producer, director, or any other real person involved in creating the media asset. In some embodiments, an associated object may be a product associated with a media asset. For example, the product may be a soundtrack, a book, a toy, a game, or any other products that is related to “The Dark Knight” movie. In some embodiments, an associated object may be an advertisement associated with a media asset. For example, an associated object may be a commercial, trailer, or any other promotional activity related to “The Dark Knight” movie. In some embodiments, an associated object may be an event associated with a media asset. For example, the event may be a premier of “The Dark Knight” movie, a broadcast, delivery, or release time of “The Dark Knight” movie, or any promotional event associated with “The Dark Knight” movie.

Illustrative examples of associated objects are shown as selectable items in a list as part of user interface 800. Each item 810, 820, 830, 840, 850 corresponds to its own respective object, noted by object names 814, 824, 834, 844, and 854, respectively. In some embodiments, each object may be associated with a representative image or icon 812, 822, 832, 842, and 852, respectively. Control circuitry of remote server 415 may determine a particular ranking of items in the list based on level of popularity associated with a given associated object. In some embodiments, control circuitry of remote server 415 may determine the popularity level of a given object by determining the number of “likes” associated with a particular object. A “like” is given to an object when a user selects an option indicating approval or praise for a particular object. Control circuitry of remote server 415 may than list the associated objects in order of popularity level, with the object with the highest popularity level listed first. As shown in illustrative user interface 800, the highest ranked associated object 810 is “Batman: The Dark Knight (Movie)” 814. This highest ranked object 810 has the highest number of likes 816 compared to all other objects in the list (see number of likes 826, 836, and 846).

In some embodiments, control circuitry of remote server 415 may rank the objects in the list by criteria other than or in combination with popularity level. For example, this other criteria may be a textual matching score between the selected portion 804 of the message and the names of associated objects. In such instances, the more similar an object's name is to the selected word/phrase 804, the higher its textual matching score. Control circuitry of remote server 415 may determine this level of textual matching during the text recognition process of the submitted message when the message is submitted by a user 802.

A user may select one of the items from the list of associated objects (e.g., shown in user interface 800) as a match for the selected portion 804 of the message. For example, a user may select the highest ranking object in the list as the match for the selected word/phrase 804 of the message. In response to receiving the user selection of the matching object, control circuitry of remote server 415 may link the selected word/phrase 804 to the user-selected object (e.g. “The Dark Knight” movie) from the list. Control circuitry of remote server 415 may perform this linking by embedding the link in the message and re-posting the linked message. The re-posted linked message may look like message 600 or message 700, as discussed in relation to FIGS. 6 and 7 above.

FIG. 9 is an illustrative flow chart 900 for a process to automatically link a portion of a message that is submitted to a server in accordance with some embodiments of the disclosure. At step 902, a user submits a message to remote server 415. In some embodiments, unlinked message 500 may be a message that is submitted to a server 415 that hosts a website. For example, the server 415 may host webpages corresponding to a social networking website. In other embodiments, unlinked message 500 may be an email that is submitted to an email server 415. In yet other embodiments, unlinked message 500 may be a text message that is submitted from a user's mobile device (e.g., wireless user communications device 506) to a telecommunications server 415 that stores text messages. This submitted message may be any one of the submitted message discussed in relation to FIGS. 5, 6, and 7.

In response to receiving the submitted message at step 902, control circuitry of remote server 415 may or may not store the submitted message in storage. In some embodiments, the storage may be located at remote server 415. In some embodiments, the storage may be located in a server that is separate from remote server 415. In some embodiments, the storage may be located on a user equipment device 300. At step 904, control circuitry of remote server 415 retrieves the stored submitted message and performs text recognition on the retrieved message. As part of the text recognition, control circuitry of remote server 415 processes all the text in the submitted message and identifies individual words in the message. Control circuitry of remote server 415 may also process the identified individual words to identify phrases in the message.

At step 906, control circuitry of remote server 415 determines whether the message includes words and/or phrases that are associated with a media asset based on the identified words and phrases that resulted from the text recognition. In some embodiments, control circuitry of remote server 415 may perform this determination by retrieving a list of words/phrases that relate to media assets. This list may be stored local to remote server 415 or on a separate server or user equipment device. As referred to herein “list” should be understood to include one or more lists retrieved from one or more storages. For example, the list of words/phrases that relate to media assets may be stored and retrieved from media guidance data source 418 or media content source 416. In another example, control circuitry of remote server 415 may retrieve this list of words/phrases from a cross-referencing database, where the list of words/phrases represents the list of keys to each entry in the database and each key (e.g., word/phrase) is cross-referenced with one or more associated objects that is related to a media asset. In some embodiments, the retrieved list may contain words/phrases that correspond to names of media assets. For example, the retrieved list may contain, but is not limited to, titles of all movies, television series, television episodes, music albums, and individual songs. Additionally or alternatively, the retrieve list may contain actors, characters, directors, producers, or any other person involved in creating one or more media assets.

Once control circuitry of remote server 415 retrieves the list of words/phrases, control circuitry of remote server 415 may determine whether the submitted message includes any words/phrases that are associated with a media asset at step 906 by checking whether any of the identified words/phrases in the message is a word/phrase in the retrieved list of words/phrase related to media assets. In response to determining that at least one of the identified words/phrases in the message is in the retrieved list of words/phrase related to media assets, control circuitry of remote server 415 proceeds to step 910. Alternatively, if control circuitry of remote server 415 determines that none of the identified words/phrase in the message is in the retrieved list of words/phrases that are related to media assets, control circuitry of remote server 415 proceeds to step 908 and ends the automatic linking process 900. As a result, the message that is submitted to remote server 415 at step 902 remains unlinked.

At step 910, control circuitry of remote server 415 selects a portion of the message that corresponds to the word/phrase that exists in the retrieved list of words/phrases related to media assets. For example, if the submitted message is any one of messages 500, 600, or 700, control circuitry of remote server 415 may determine that the phrase “The Dark Knight” (e.g., 504, 604, 704) corresponds to a media asset by determining that “The Dark Knight” belongs on a retrieved list of movie titles.

At step 912, control circuitry of remote server 415 cross-references the selected portion of the message (e.g., “The Dark Knight”) with a database to identify objects that are associated with the selection portion of the message. This cross-referencing database may be stored locally on remote server 415 or in a separate server located at media guidance data source 418 or media content source 416 or user equipment device 300. As a result of the cross-referencing, control circuitry of remote server 415 may retrieve a plurality of objects that are associated with the portion of the message. For example, control circuitry of remote server 415 may determine that one or more of following types of objects are associated with the media asset referred to by the selected portion at step 910: an object related to a media asset (e.g., “The Dark Knight” movie object), a character in the media asset (e.g., “The Joker”, “Batman”), a real person associated with the media asset (e.g., the actor “Christian Bale” who plays the role of “Batman” in the movie, the director “Christopher Nolan” who directs the movie), media assets with similar titles (e.g., “The Dark Knight Rises”), and descriptors for the content of the media asset (e.g., superhero, comics, etc.).

At step 914, control circuitry of remote server 415 may determine values to rank the associated objects. In some embodiments, control circuitry of remote server 415 may determine values what indicate the popularity of each of the associated objects. For example, one metric of popularity may be the number of “likes” associated with an object. In such instances, control circuitry of remote server may assign the popularity value of an object based on the number of “likes” given for a particular object. In some embodiments, control circuitry of remote server 415 may determine values that indicate how well an object's name matches with the selected portion of the message. In any of the above-mentioned embodiments for determining values, control circuitry of remote server 415 may compute the values locally or retrieve the values from another server (e.g., at media guidance data source 418 or media content source 416) or user equipment device 300.

At step 916, control circuitry of remote server 415 may rank the plurality of associated objects such that higher ranked associated objects correspond to “better” matches with the selected portion of the message. In some embodiments, control circuitry of remote server 415 may rank the associated objects based on the determined popularity values. For example, as discussed in relation object items 810, 820, 830, 840, and 850, control circuitry of remote server 415 may assign the object with the highest number of “likes” with the highest rank (e.g., see object 810 with the highest number of likes 816).

In some embodiments, control circuitry of remote server 415 may rank the plurality of associated objects at step 914 based on textual matching score such that higher ranked associated objects correspond to objects with names that are more similar to the selected portion of the message (e.g., “The Dark Knight”). For example, control circuitry of remote server 415 may assign the movie object “The Dark Knight Rises” with a higher rank than the movie object “Darkness Falls” (not shown in FIG. 8) because “The Dark Knight Rises” has more words in common with the selected portion (e.g., “The Dark Knight”) than does “Darkness Falls”.

Control circuitry of remote server 415 may rank the associated objects at step 916 based on one or more types of values determined at step 914. For example, control circuitry of remote server 415 may assign a ranking based on a composite score of an object's determine popularity value and textual matching score.

At step 918, control circuitry of remote server 415 determines whether a user has selected any of the ranked list of associated objects as a match for the selected portion of the message (e.g., “The Dark Knight”). In some embodiments, the user may select the best match from a displayed list of associated objects. Details on this user selection were discussed in relation to user interface 800 in FIG. 8. Control circuitry of remote server 415 may display higher ranking objects closer to the top of the list (e.g., see objects 810 and 820) so that a user may more quickly detect and select better matches. Allowing a user to select the best matching object improves the accuracy of the linking process. In response to receiving a user selection of a match at step 918, control circuitry of remote server 415 stores the user-selected match at step 922. This user-selected match may be stored locally in storage of remote server 415 or in storage that is remote to remote server 415.

In response to determining that a user has not selected a matching object at step 918, control circuitry of remote server 415 may proceed to step 920 and automatically select the match based on the highest ranking object in the list. In some embodiments, control circuitry of remote server 415 will automatically link the selected portion of the message (e.g., “The Dark Knight”) to the highest ranking object in the list, as determined in step 916, without providing the user with an opportunity to select the best match. In some embodiments, control circuitry of remote server 415 will generate for display the automatically selected matching object (e.g., highest ranking object in the list) and provide the user with an option to correct the automatically selected match or proceed without correction. In response to receiving a user selection to correct the automatically server-selected match, control circuitry of remote server 415 proceeds to step 922 and stores the user-selected corrected version of the match. In response to receiving a user selection to proceed with the automatically-selected match, control circuitry of remote server 415 proceeds to step 922 and stores the automatically-selected match at step 920 in storage.

Once the selected match is stored at step 922, control circuitry of remote server 415 determines whether any links exist for the stored selected match at step 924. Control circuitry of remote server 415 may perform this determination in any number of ways. In some embodiments, control circuitry of remote server 415 accesses a cross-referencing database which associates objects related to media assets with links to those objects. This database may be stored locally at remote server 415 or at a remote location such as media guidance data source 418, media content source 416, or user equipment device 300. In response to determining at step 924 that the matching object is cross-referenced with at least one link, control circuitry of remote server 415 proceeds to select the most popular link at step 926. In response to determining at step 924 that the matching object is not cross-referenced with any links, control circuitry of remote server 415 proceeds to step 908, which ends to linking process.

In some embodiments, control circuitry of remote server 415 may initiate a web search using the name of the matching object as the search query. For example, if “The Dark Knight” movie object is stored as the select match at step 922, control circuitry of remote server 415 may initiate a search of the query “The Dark Knight” or “The Dark Knight Movie” in a search engine. Control circuitry of remote server 415 then selects at step 920 the highest ranked search results from the resulting list of the search as the most popular link. In response to determining that no search results exist for the query, control circuitry of remote server 415 proceeds to step 908 to end the linking process.

Once the most popular link is selected at step 926, control circuitry of remote server proceeds to step 928 to modify the message (submitted at step 902) to visually distinguish the selected portion as the selected link (selected at step 926). In some embodiments, control circuitry of remote server 415 embeds the selected link in the submitted message using HTML such that a selection of the selected portion (e.g., “The Dark Knight”) of the message will automatically direct the user to the linked information source. Further details about this type of linking were discussed in relation to FIG. 6.

In some embodiments, control circuitry of remote server 415 may additionally or alternatively access the content from the linked information source and modify the submitted message to include a snapshot of that accessed content. For example, this snapshot may be a textual blurb from the linked information source. In another example, this snapshot may be the content itself that is discussed in the information source. If so, control circuitry of remote server 415 may generate for display an option to play at least a portion of the content in the modified message. Further details about this type of linking were discussed in relation to FIG. 7. Subsequently, control circuitry of remote server 415 may generated for displayed the modified, linked version of the submitted message. This modified message may be displayed as a message post in a webpage (e.g., social networking webpage, blog, commentary section of a website), an email in an email application, a text message in a text messaging application implemented on user computer equipment 404 or wireless user communications device 406, or any other form of messaging display. Illustrative examples of posted linked messages were discussed in relation to FIGS. 6 and 7 above.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 9.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for automatically linking portions of a message, the method comprising:
storing a message that was submitted to a server;
performing text recognition on the message that was stored;
selecting a portion of the message based on the performed text recognition;
automatically identifying, without receiving user input to identify, a plurality of objects associated with the selected portion, wherein each of the plurality of associated objects is cross-referenced, in a database, with the selected portion of the message;
selecting an object, from the identified plurality of associated objects, as a match for the selected portion of the message;
modifying the message, wherein the modifying comprises visually distinguishing the selected portion of the message as a selectable link to a display related to the selected object; and
generating for display the modified message.

2. The method of claim 1, wherein the performing text recognition comprises:
identifying a word or a phrase, from the message, that is associated with a media asset, wherein the selected portion of the message is the identified word or phrase.

3. The method of claim 1, wherein:
the message was submitted to the server in response to a user selection of an option to post the message on a webpage hosted by the server, and
the submitted message is not displayed prior to the performing of text recognition on the message.

4. The method of claim 1, wherein each of the plurality of objects is one of a media asset, a person associated with a media asset, a product associated with a media asset, an advertisement associated with a media asset, and an event associated with a media asset.

5. The method of claim 1, further comprising:
generating for display the submitted message on a webpage that is hosted by the server, wherein the submitted message is displayed prior to display of the modified message.

6. The method of claim 5, further comprising:
receiving a user selection of an option to create a link for the displayed submitted message;
in response to receiving the user selection of the option to create a link, generating for display a list of the plurality of associated objects, wherein each of the plurality of associated objects is selectable by a user; and
receiving a user selection of an object from the displayed list of the plurality of associated objects, wherein the user-selected object is the match for the selected portion of the message.

7. The method of claim 1, wherein the match is automatically selected by the server, without receiving user input to select the match.

8. The method of claim 7, further comprising:
determining a value that indicates a level of popularity of each of the identified plurality of associated objects, wherein the match that is automatically selected by the server is the object with the highest determined value.

9. The method of claim 1, wherein the message is a text message submitted from a mobile phone.

10. The method of claim 1, wherein the display related to the selected object is a web page that provides information related to a media asset, wherein the information includes at least one of:
a description of the media asset,
a person associated with the media asset,
media assets that are related to the media asset,
availability of the media asset,
information for accessing the media asset, and
commentary about the media asset posted by users.

11. A system for automatically linking portions of a message, the system comprising:
storage circuitry configured to:
store a message that was submitted to a server; and
control circuitry configured to:
perform text recognition on the message that was stored;
select a portion of the message based on the performed text recognition;
automatically identify, without receiving user input to identify, a plurality of objects associated with the selected portion, wherein each of the plurality of associated objects is cross-referenced, in a database, with the selected portion of the message;
select an object, from the identified plurality of associated objects, as a match for the selected portion of the message;
modify the message, wherein the modifying comprises visually distinguishing the selected portion of the message as a selectable link to a display related to the selected object; and
generate for display the modified message.

12. The system of claim 11, wherein the control circuitry configured to perform text recognition is further configured to:
identify a word or a phrase, from the message, that is associated with a media asset, wherein the selected portion of the message is the identified word or phrase.

13. The system of claim 11, wherein:
the message was submitted to the server in response to a user selection of an option to post the message on a webpage hosted by the server, and
the submitted message is not displayed prior to the performing of text recognition on the message.

14. The system of claim 11, wherein each of the plurality of objects is one of a media asset, a person associated with a media asset, a product associated with a media asset, an advertisement associated with a media asset, and an event associated with a media asset.

15. The system of claim 11, wherein the control circuitry is further configured to:
generate for display the submitted message on a webpage that is hosted by the server, wherein the submitted message is displayed prior to display of the modified message.

16. The system of claim 15, wherein the control circuitry is further configured to:
receive a user selection of an option to create a link for the displayed submitted message;
in response to receiving the user selection of the option to create a link, generate for display a list of the plurality of associated objects, wherein each of the plurality of associated objects is selectable by a user; and
receive a user selection of an object from the displayed list of the plurality of associated objects, wherein the user-selected object is the match for the selected portion of the message.

17. The system of claim 11, wherein the match is automatically selected by the server, without receiving user input to select the match.

18. The system of claim 17, wherein the control circuitry is further configured to:
determine a value that indicates a level of popularity of each of the identified plurality of associated objects, wherein the match that is automatically selected by the server is the object with the highest determined value.

19. The system of claim 11, wherein the message is a text message submitted from a mobile phone.

20. The system of claim 11, wherein the display related to the selected object is a web page that provides information related to a media asset, wherein the information includes at least one of:
a description of the media asset,
a person associated with the media asset,
media assets that are related to the media asset,
availability of the media asset,
information for accessing the media asset, and
commentary about the media asset posted by users.

21-50. (canceled)
